(19) United States
(12) Patent Application Publication
(10) Pub. No.: US 2025/0377039 A1
(43) Pub. Date: Dec. 11, 2025

(54) VARIABLE DEPTH SEAL GROOVES, SYSTEMS, AND METHODS

(71) Applicant: Battelle Energy Alliance, LLC, Idaho Falls, ID (US)

(72) Inventor: Nathan M. PETERSEN, Idaho Falls, ID (US)

(73) Assignee: Battelle Energy Alliance, LLC, Idaho Falls, ID (US)

(21) Appl. No.: 19/227,784

(22) Filed: Jun. 4, 2025

Related U.S. Application Data
(60) Provisional application No. 63/656,420, filed on Jun. 5, 2024.

(51) Int. Cl. F16J 15/06; E06B 7/22

(52) U.S. Cl. CPC F16J 15/062; E06B 7/22

(57) ABSTRACT

A sealable chamber may include a chamber aperture, an aperture border, a first surface encompassing the chamber aperture, a chamber door having a second surface configured to at least partially engage against the first surface of the aperture border, and a seal positioned intermediate the first surface and the second surface. The chamber door may have a non-circular shape. At least a portion of the second surface of the chamber door may exhibit nonuniform deflection relative to the first surface of the aperture border when a compression force is applied to the chamber door to compress the second surface against the first surface. An exposed height of the seal intermediate the first surface and the second surface may be configured to vary and compensate for the nonuniform deflection to maintain a hermetic seal between the first surface and the second surface.

### CROSS-REFERENCE TO RELATED APPLICATIONS

This application claims the benefit of U.S. Provisional Patent Application Ser. No. 63/656,420 filed on Jun. 5, 2024, entitled “VARIABLE DEPTH SEAL GROOVES, SYSTEMS, AND METHODS”. The above-referenced document is hereby incorporated by reference in its entirety.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The present disclosure relates to non-circular plates with seal structures configured to compensate for nonuniform deflection. More specifically, the present disclosure relates to non-circular doors with variable depth seal grooves configured to compensate for nonuniform deflection when the non-circular doors are compressed.

### BACKGROUND

In certain applications, sealable chambers (e.g., gloveboxes, hot cells, autoclaves, etc.) may require sealed doors with non-circular shapes (e.g., square, rectangular, trapezoid, polygonal, oval, etc.) to allow sufficient ingress/egress space for larger items that are placeable within the sealable chambers.

Sealable chambers typically incorporate a centrally located compression mechanism (e.g., a screw-type or over-center latch compression mechanism) that compresses the door against a face of the sealable chamber (and thereby compresses a seal positioned intermediate the door and the face of the sealable chamber) to maintain a tight hermetic seal between the sealable chamber and the outside atmosphere that ensures personnel safety and prevents internal and/or external contamination.

However, non-circular doors placed under a centrally located compression force can experience nonuniform deflection along the edges of the door (and/or corners of the door, if applicable) that may create possible leak paths around the seal. This can be mitigated, at least to some extent, by adding structural reinforcements to the door that help it resist nonuniform deflection when placed under pressure. For example, multiple radial ribs can be added to the door that will provide extra rigidity and resistance against nonuniform deflection when placed under pressure. Unfortunately, such reinforcing structures also add additional weight, complexity, manufacturing costs, and future maintenance issues to such door designs.

Accordingly, non-circular shaped doors with seal structures configured to compensate for nonuniform deflection that are lighter, simpler, less costly, and more easily maintained, would be desirable.

### SUMMARY

The variable depth seal grooves, systems, and methods of the present disclosure have been developed in response to the present state of the art, and in particular, in response to the problems and needs in the art that have not yet been fully solved by currently available sealable chambers. In some embodiments, the variable depth seal grooves, systems, and methods of the present disclosure may provide improved sealable chambers that can maintain a hermetic seal within the sealable chamber by varying an exposed height of a seal to compensate for nonuniform deflection of the chamber door under compression.

In some embodiments, a sealable chamber may include a chamber aperture, an aperture border, a first surface encompassing the chamber aperture, a chamber door having a second surface configured to at least partially engage against the first surface of the aperture border, and a seal positioned intermediate the first surface and the second surface. The chamber door may have a non-circular shape. At least a portion of the second surface of the chamber door may exhibit nonuniform deflection relative to the first surface of the aperture border when a compression force is applied to the chamber door to compress the second surface against the first surface. An exposed height of the seal intermediate the first surface and the second surface may be configured to vary and compensate for the nonuniform deflection to maintain a hermetic seal between the first surface and the second surface.

The sealable chamber according to any preceding paragraph, wherein at least one of the first surface of the aperture border and the second surface of the chamber door may include a groove configured to at least partially receive the seal therein, and a depth of the groove may be configured to vary the exposed height of the seal to compensate for the nonuniform deflection and maintain the hermetic seal between the first surface and the second surface.

The sealable chamber according to any preceding paragraph, wherein the first surface of the aperture border may include the groove configured to at least partially receive the seal therein, and the depth of the groove in the first surface may be configured to vary the exposed height of the seal to compensate for the nonuniform deflection and maintain the hermetic seal between the first surface and the second surface.

The sealable chamber according to any preceding paragraph, wherein the second surface of the chamber door may include the groove configured to at least partially receive the seal therein, and the depth of the groove in the second surface may be configured to vary the exposed height of the seal to compensate for the nonuniform deflection and maintain the hermetic seal between the first surface and the second surface.

The sealable chamber according to any preceding paragraph, wherein the groove may include a first depth at a first location within the groove, and a second depth at a second location within the groove. The depth of the groove may be configured to continuously decrease moving from the first depth at the first location toward the second depth at the second location to vary the exposed height of the seal and compensate for the nonuniform deflection to maintain the hermetic seal between the first surface and the second surface.

The sealable chamber according to any preceding paragraph, wherein the groove comprises a first depth at a first location within the groove, and a second depth at a second location within the groove. The depth of the groove may be configured to discretely decrease moving from the first depth at the first location toward the second depth at the second location to vary the exposed height of the seal and compensate for the nonuniform deflection to maintain the hermetic seal between the first surface and the second surface.

The sealable chamber according to any preceding paragraph, wherein the non-circular shape of the chamber door may include at least one of a polygonal shape having at least one straight side, and a curved shape comprising at least one curved side.

In some embodiments, a sealable chamber may include a chamber aperture, an aperture border having a first surface encompassing the chamber aperture, a chamber door having a polygonal shape and a second surface configured to at least partially engage against the first surface of the aperture border, and a seal positioned intermediate the first surface of the aperture border and the second surface of the chamber door. At least a portion of the second surface of the chamber door may exhibit nonuniform deflection relative to the first surface of the aperture border when a compression force is applied to the chamber door to compress the second surface against the first surface. An exposed height of the seal intermediate the first surface and the second surface may be configured to vary and compensate for the nonuniform deflection to maintain a hermetic seal between the first surface and the second surface.

The sealable chamber according to any preceding paragraph, wherein at least one of the first surface of the aperture border and the second surface of the chamber door includes a groove configured to at least partially receive the seal therein, and a depth of the groove may be configured to vary the exposed height of the seal to compensate for the nonuniform deflection and maintain the hermetic seal between the first surface and the second surface.

The sealable chamber according to any preceding paragraph, wherein the second surface of the chamber door includes the groove configured to at least partially receive the seal therein, and the depth of the groove in the second surface may be configured to vary the exposed height of the seal to compensate for the nonuniform deflection and maintain the hermetic seal between the first surface and the second surface.

The sealable chamber according to any preceding paragraph, wherein the groove may include an intermediate depth at an intermediate portion along at least one side of the chamber door, and a corner depth at a corner of the chamber door. The depth of the groove may be configured to decrease moving from the intermediate depth toward the corner depth to vary the exposed height of the seal and compensate for the nonuniform deflection to maintain the hermetic seal between the first surface and the second surface.

The sealable chamber according to any preceding paragraph, wherein the polygonal shape of the chamber door may include at least three sides and at least three corners.

The sealable chamber according to any preceding paragraph, wherein the polygonal shape may include at least one of: a triangular shape, a square shape, a rectangular shape, a trapezoidal shape, and a rhomboid shape.

The sealable chamber according to any preceding paragraph, further including a compression mechanism configured to apply the compression force to the chamber door to compress the second surface against the first surface.

In some embodiments, a sealable chamber may include a sealable chamber wall having a chamber aperture formed therethrough and an aperture border with a first surface encompassing the chamber aperture, a chamber door having a curved shape and a second surface configured to at least partially engage against the first surface of the sealable chamber wall, and a seal positioned intermediate the first surface of the sealable chamber wall and the second surface of the chamber door. At least a portion of the second surface of the chamber door may exhibit nonuniform deflection relative to the first surface of the sealable chamber wall when a compression force is applied to the chamber door to compress the second surface against the first surface. An exposed height of the seal intermediate the first surface and the second surface may be configured to vary and compensate for the nonuniform deflection to maintain a hermetic seal between the first surface and the second surface.

The sealable chamber according to any preceding paragraph, wherein at least one of the first surface of the sealable chamber wall and the second surface of the chamber door may include a groove configured to at least partially receive the seal therein, and a depth of the groove may be configured to vary the exposed height of the seal to compensate for the nonuniform deflection and maintain the hermetic seal between the first surface and the second surface.

The sealable chamber according to any preceding paragraph, wherein the second surface of the chamber door may include the groove configured to at least partially receive the seal therein, and the depth of the groove in the second surface may be configured to vary the exposed height of the seal to compensate for the nonuniform deflection and maintain the hermetic seal between the first surface and the second surface.

The sealable chamber according to any preceding paragraph, wherein the groove may include at least one of: a triangular groove, a square groove, a rounded groove, a half dovetail groove, and a full dovetail groove.

The sealable chamber according to any preceding paragraph, wherein the curved shape comprises at least one of: an oval shape, an ovoid shape, an oblong circular shape, and an elliptical shape.

The sealable chamber according to any preceding paragraph, wherein the seal comprises at least one of: an O-ring, an X-ring, a square-ring, and a delta-ring.

These and other features and advantages of the present disclosure will become more fully apparent from the following description and appended claims or may be learned by the practice of the variable depth seal grooves, systems, and methods set forth hereinafter.

### BRIEF DESCRIPTION OF THE DRAWINGS

Exemplary embodiments of the present disclosure will become more fully apparent from the following description taken in conjunction with the accompanying drawings. Understanding that these drawings depict only exemplary embodiments and are, therefore, not to be considered limiting of the scope of the present disclosure, the exemplary embodiments of the present disclosure will be described with additional specificity and detail through use of the accompanying drawings in which:

FIG. 1 illustrates a perspective front view of a sealable chamber comprising an autoclave, according to an example of the present disclosure;

FIG. 2 illustrates a perspective view of a sealable chamber comprising a glovebox, according to an example of the present disclosure;

FIG. 3 illustrates a perspective view of a sealable chamber comprising a glovebox, according to another example of the present disclosure;

FIG. 4 illustrates a perspective view of a door and compression mechanism for a sealable chamber, according to an example of the present disclosure;

FIG. 5 illustrates a perspective view of a door and compression mechanism for a sealable chamber, according to another example of the present disclosure;

FIG. 6 illustrates a perspective view of a simply supported plate placed under pressure, according to an example of the present disclosure;

FIG. 7 illustrates a perspective view of a door for a sealable chamber placed under pressure, according to an example of the present disclosure;

FIG. 8 illustrates an exploded view of a door and compression mechanism for a sealable chamber, according to an example of the present disclosure;

FIG. 9 illustrates a perspective view of the door and compression mechanism of FIG. 8, after assembly;

FIG. 10 illustrates a side view of the assembled door and compression mechanism from FIG. 9;

FIG. 11 illustrates a cross-sectional perspective view of the assembled door and compression mechanism from FIG. 9;

FIG. 12 illustrates a cross-sectional side view of the assembled door and compression mechanism from FIG. 9;

FIG. 13 illustrates a cross-sectional side view of a portion of the assembled door and compression mechanism from FIG. 12;

FIG. 14 illustrates a perspective view of door with a square shape, according to an example of the present disclosure;

FIG. 15 illustrates a cross-sectional side view of the door from FIG. 14;

FIG. 16 illustrates a cross-sectional side view of a triangular or corner-shaped groove with an O-ring seal placed therein, according to an example of the present disclosure;

FIG. 17 illustrates a cross-sectional side view of a square-shaped groove with an O-ring seal placed therein, according to another example of the present disclosure;

FIG. 18 illustrates cross-sectional side views for various square-shaped grooves with different seals placed therein, according to examples of the present disclosure;

FIG. 19 illustrates a cross-sectional side view of a half dovetail groove with an O-ring seal placed therein, according to an example of the present disclosure;

FIG. 20 illustrates a cross-sectional side view of a full dovetail groove with an O-ring seal placed therein, according to another example of the present disclosure;

FIG. 21 illustrates a side view of door with a trapezoid shape, according to an example of the present disclosure; and

FIG. 22 illustrates a side view of door with an oval shape, according to another example of the present disclosure.

It is to be understood that the drawings are for purposes of illustrating the concepts of the present disclosure and may not be drawn to scale. Furthermore, the drawings illustrate exemplary embodiments and do not represent limitations to the scope of the present disclosure.

### DETAILED DESCRIPTION

Exemplary embodiments of the present disclosure will be best understood by reference to the drawings, wherein like parts are designated by like numerals throughout. It will be readily understood that the components of the present disclosure, as generally described and illustrated in the drawings, could be arranged and designed in a wide variety of different configurations. Thus, the following more detailed description of the embodiments of the devices, systems, and methods, as represented in the drawings, is not intended to limit the scope of the present disclosure but is merely representative of exemplary embodiments of the present disclosure.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in the drawings, the drawings are not necessarily drawn to scale unless specifically indicated.

As used herein, the terms “polygon” or “polygonal shape” can comprise any closed shape that may include at least one identifiable corner where two sides of the polygon meet (e.g., may include straight/sharp corners or curved corners where two sides of the polygon meet).

As used herein, the term “curved shape” can comprise any closed shape comprising curved sides that may or may not include at least one identifiable corner where two sides of the curved shape meet (e.g., oval shapes, elliptical shapes, ovoid shapes, and/or any other oblong/distorted round shapes, etc.).

It will be understood that any sealable chamber or any sealable chamber feature that is described or contemplated herein may (or may not) include any configuration, feature, or morphology that is described or contemplated herein with respect to any other sealable chamber or any other sealable chamber feature that is described or contemplated herein to form any number of different sealable chamber embodiments.

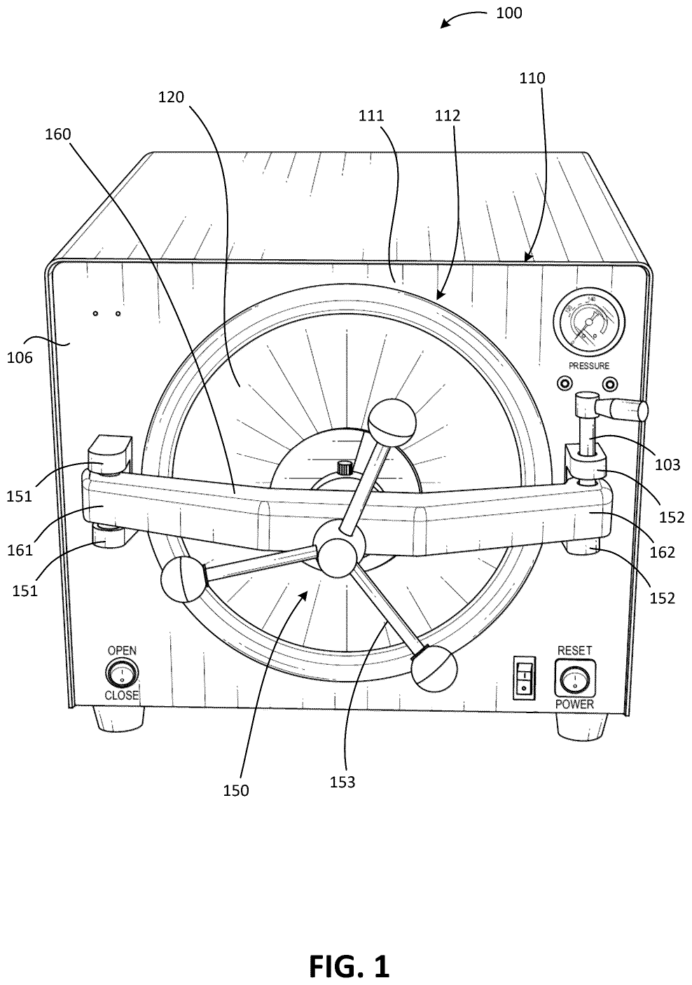

FIG. 1 shows a sealable chamber 100 that may comprise an autoclave, according to an example of the present disclosure. However, it will be understood that any of the sealable chambers described or contemplated herein may comprise any form of hermetically sealable container including, but not limited to a glove box, a hot cell, a vacuum chamber, a pressurized chamber, an autoclave, etc.

The sealable chamber 100 may generally include a removable breach, hatch, opening, ingress, face plate, or chamber door 120 that may be configured to cover and seal a chamber aperture 112 (behind the chamber door 120 in FIG. 1) to maintain a hermetic seal within the sealable chamber 100. The chamber aperture may be formed in a wall 106 of the sealable chamber and may include an aperture border 110 that encompasses the chamber aperture to receive the chamber door 120 thereon.

The sealable chamber 100 may also include a centrally located compression mechanism, over-center latch compression mechanism, or compression mechanism 150 that may be configured to apply a compression force to the chamber door 120 to maintain the hermetic seal within the sealable chamber 100. The compression mechanism 150 may include a compression arm 160 that may be pivotally coupled to a first compression arm support 151 at a first end 161 of the compression arm 160. A second end 162 of the compression arm 160 may be lockable to a second compression arm support 152 via a removable locking pin 103. The compression mechanism 150 may also include a rotatable compression handle, or handle 153, that may be configured to apply a centrally located compression force to the chamber door 120 to help maintain the hermetic seal within the sealable chamber 100.

In the example shown in FIG. 1, the chamber door 120 may comprise a circular shape that may not experience nonuniform deflection when the compression mechanism 150 applies a centrally located compression force to the chamber door 120 to compress it against a first surface 111 of the aperture border 110 that surrounds the chamber aperture (shown covered by the chamber door 120 in FIG. 1) that is formed in the sealable chamber 100. However, in certain applications a door having a non-circular shape (e.g., square, rectangular, trapezoid, polygonal, oval, etc.) may be desirable to enable sufficient ingress/egress space for larger items, or for items with certain shapes, which may be placed within the sealable chamber 100.

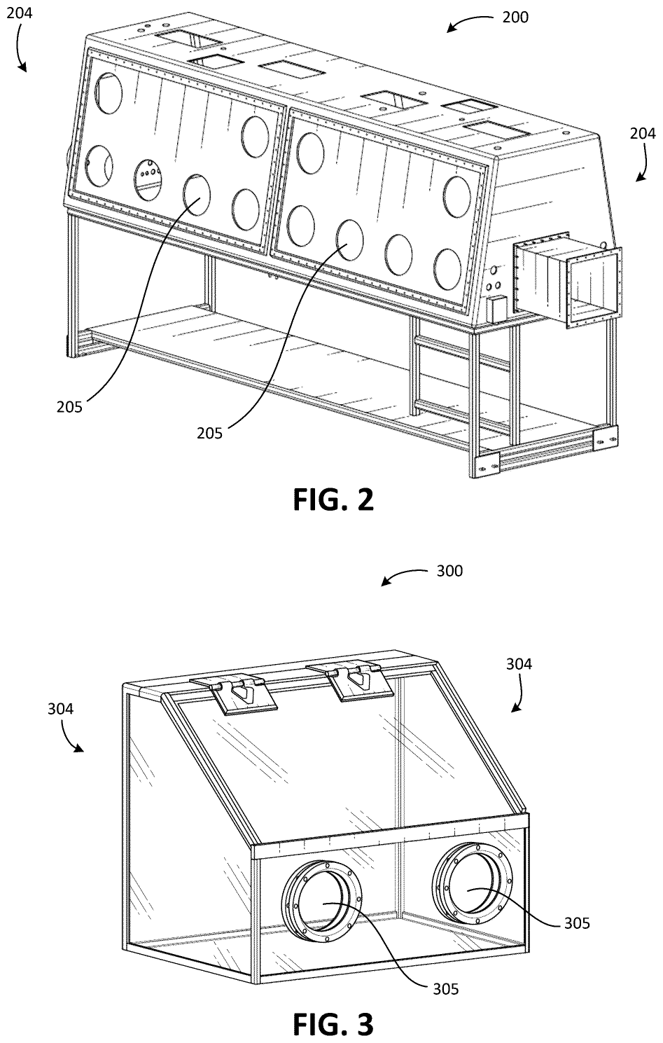

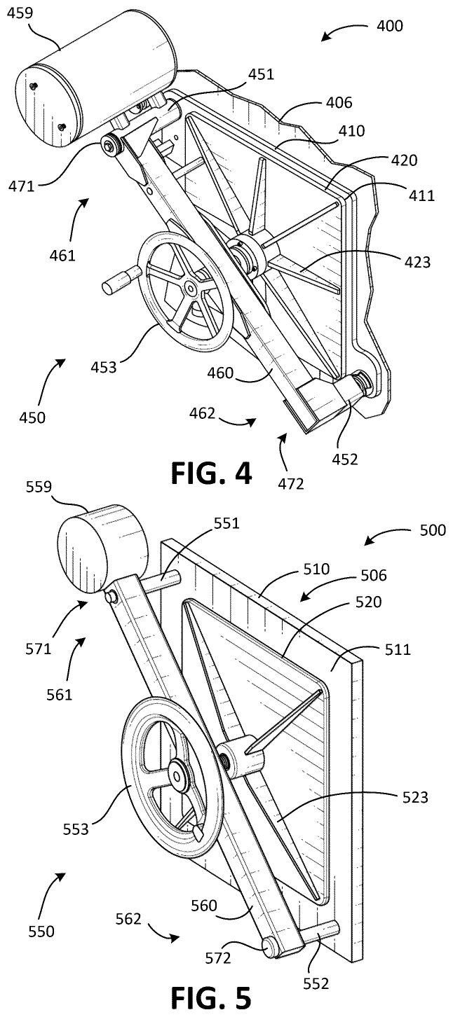

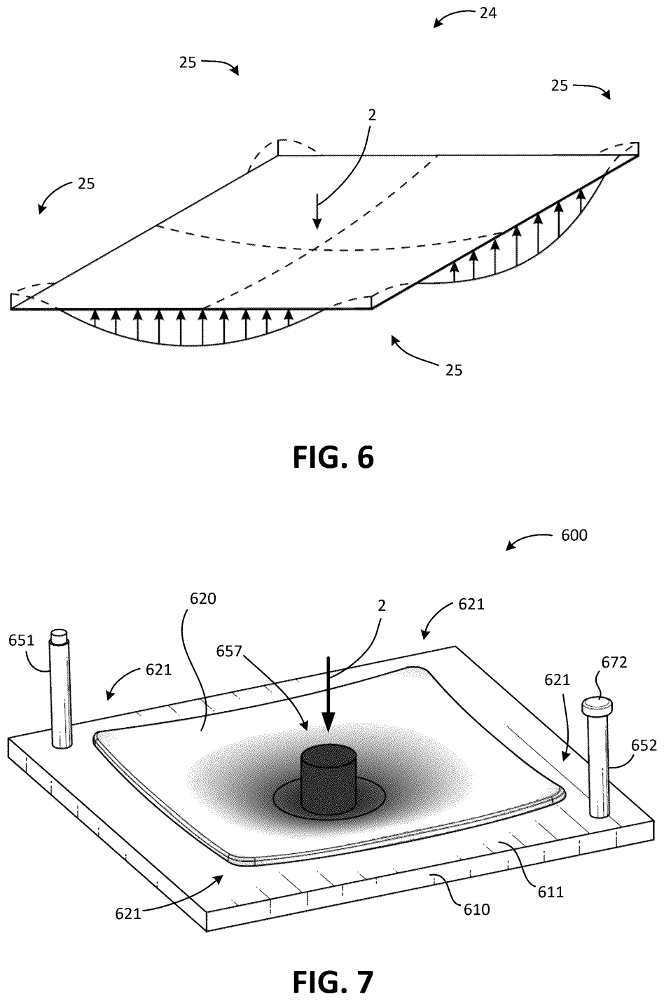

FIGS. 2 and 3 show other example sealable chambers (e.g., a glovebox 200 and a glovebox 300) which may include one or more glove openings 205, 305 to enable manual manipulation of objects placed therein. The example sealable chambers shown in FIGS. 2 and 3 may also include one or more breachable sides 204, 304 that may comprise square, rectangular, trapezoidal, and/or other polygonal shapes (or substantially polygonal shapes) or curved/non-polygonal shapes, etc., formed therein (not shown in FIGS. 2 and 3). Thus, it may be advantageous to utilize chamber doors with corresponding square, rectangular, trapezoidal, and/or other polygonal shapes or oval shapes, etc., to achieve maximum ingress/egress space for larger items (or items with certain shapes) that may be placed therein. However, non-circular doors placed under pressure can experience nonuniform deflection along the edges of the door (and/or at the corners of the door, if present) which may create possible leak paths around the seal, as will be discussed below in more detail with respect to FIGS. 6 and 7. This may be mitigated, at least to some extent, by adding structural reinforcements to the door to help the door resist nonuniform deflection when placed under pressure. For example, FIGS. 4 and 5 show square chamber doors for sealable chambers 400, 500 that may include one or more chamber door ribs, or radial ribs, coupled to the chamber doors to provide extra rigidity and resistance against nonuniform deflection when the chamber doors are compressed by their respective compression mechanisms. Alternatively, or in addition thereto, the chamber doors themselves may be made from a stronger/denser/heavier material (and/or made thicker) to provide extra rigidity and resistance against nonuniform deflection when placed under compression. Unfortunately, all of these reinforcement design choices will also result in additional weight, complexity, manufacturing costs, and/or maintenance issues for these reinforced doors. For example, it may be necessary to remove a chamber door periodically to service an interior space of a sealable chamber and/or relocate the sealable chamber to another location. However, these added reinforcements to the chamber door can increase its weight by hundreds of pounds (or even thousands of pounds in some instances), making it extremely difficult, impractical, or even impossible to properly service and/or relocate the sealable chamber.

FIG. 4 shows a portion of a sealable chamber 400 that may generally include a removable breach, hatch, opening, ingress, face plate, or chamber door 420 that may be configured to cover and seal a chamber aperture that is formed in wall 406 or an aperture border 410 of the sealable chamber 400 (shown covered by the chamber door 420 in FIG. 4) to maintain a hermetic seal therein. The chamber door 420 may include one or more chamber door ribs 423 to provide extra rigidity for the chamber door 420. The sealable chamber 400 may also include a centrally located compression mechanism, over-center latch compression mechanism, or compression mechanism 450 that may be configured to apply a compression force to the chamber door 420 to maintain the hermetic seal within the sealable chamber 400. The compression mechanism 450 may include a compression arm 460 that may be pivotally coupled to a first compression arm support 451 at a first end 461 of the compression arm 460, and a second end 462 that may be removably couplable to a second compression arm support 452. The compression mechanism 450 may also include a first compression arm retainer 471 and/or a second compression arm retainer 472 that can respectively hold the compression arm 460 in place at the first compression arm support 451 and/or at the second compression arm support 452 during compression. The chamber door 420 may also include a counterweight 459 coupled to the first compression arm support 451 to help balance the weight of the chamber door 420 and/or make it easier to pivot the chamber door 420 about the first compression arm support 451 when an operator opens the chamber door 420 to access the interior space of a sealable chamber 400 (e.g., by pivoting the chamber door 420 upward or downward). The compression mechanism 450 may also include a rotatable compression handle, or handle 453, that may be configured to apply the centrally located compression force to the chamber door 420 to compress the chamber door 420 against a first surface 411 of the aperture border 410 that surrounds the chamber aperture (shown covered by the chamber door 420 in FIG. 4) to maintain the hermetic seal.

FIG. 5 shows a portion of a sealable chamber 500 that may generally include a removable breach, hatch, opening, ingress, face plate, or chamber door 520 that may be configured to cover and seal a chamber aperture that is formed in wall 506 or an aperture border 510 of the sealable chamber 500 (shown covered by the chamber door 520 in FIG. 5) to maintain a hermetic seal therein. The chamber door 520 may include one or more chamber door ribs 523 to provide extra rigidity for the chamber door 520. The sealable chamber 500 may also include a centrally located compression mechanism, over-center latch compression mechanism, or compression mechanism 550 that may be configured to apply a compression force to the chamber door 520 to maintain the hermetic seal within the sealable chamber 500. The compression mechanism 550 may include a compression arm 560 that may be pivotally coupled to a first compression arm support 551 at a first end 561 of the compression arm 560, and a second end 562 that may be removably couplable to a second compression arm support 552. The compression mechanism 550 may also include a first compression arm retainer 571 and/or a second compression arm retainer 572 that can respectively hold the compression arm 560 in place at the first compression arm support 551 and/or at the second compression arm support 552 during compression. The chamber door 520 may also include a counterweight 559 coupled to the first compression arm support 551 to help balance the weight of the chamber door 520 and/or make it easier to pivot the chamber door 520 about the first compression arm support 551 when an operator opens the chamber door 520 to access the interior space of a sealable chamber 500 (e.g., by pivoting the chamber door 520 upward or downward). The compression mechanism 550 may also include a rotatable compression handle, or handle 553, that may be configured to apply the centrally located compression force to the chamber door 520 to compress the chamber door 520 against a first surface 511 of the aperture border 510 that surrounds the chamber aperture (shown covered by the chamber door 520 in FIG. 5) to maintain the hermetic seal.

In the examples shown in FIGS. 4 and 5, the chamber doors 420, 520 (which are square) may experience negligible nonuniform deflection during compression due to the presence of the chamber door ribs 423, 523. However, these chamber door ribs 423, 523 can result in additional weight, complexity, manufacturing costs, and/or future maintenance issues, as previously described.

FIGS. 6 and 7 illustrate the nonuniform deflection characteristics that may occur in the absence of sufficient reinforcement structures (e.g., door ribs, stronger/denser/heavier/thicker materials, etc.). For example, the nonuniform deflection characteristics shown in FIGS. 6 and 7 may occur at one or more plate corners 25 (e.g., for the simply supported plate 24 shown in FIG. 6, as well as at one or more door corners 621 for a chamber door 620 having a square shape, as shown in FIG. 7) when a compression force 2 is centrally applied to the plate 24 and/or to the chamber door 620. FIGS. 6 and 7 show how these nonuniform deflection characteristics can cause the centers of the plate 24 and/or the chamber door 620 to deform downward, while lifting the corners of the plate 24 and/or the corners of the chamber door 620 upward. These nonuniform deflection characteristics can create possible leak paths along the edges of the plate 24 and/or along the edges of the chamber door 620, especially near their corners which can “lift up” as the centrally applied compression force 2 is applied.

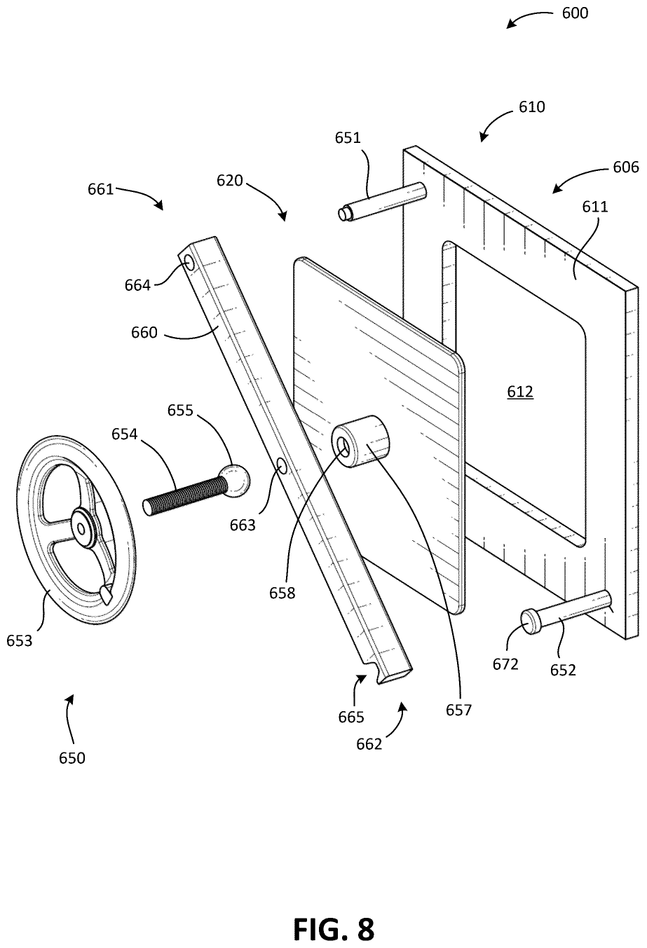

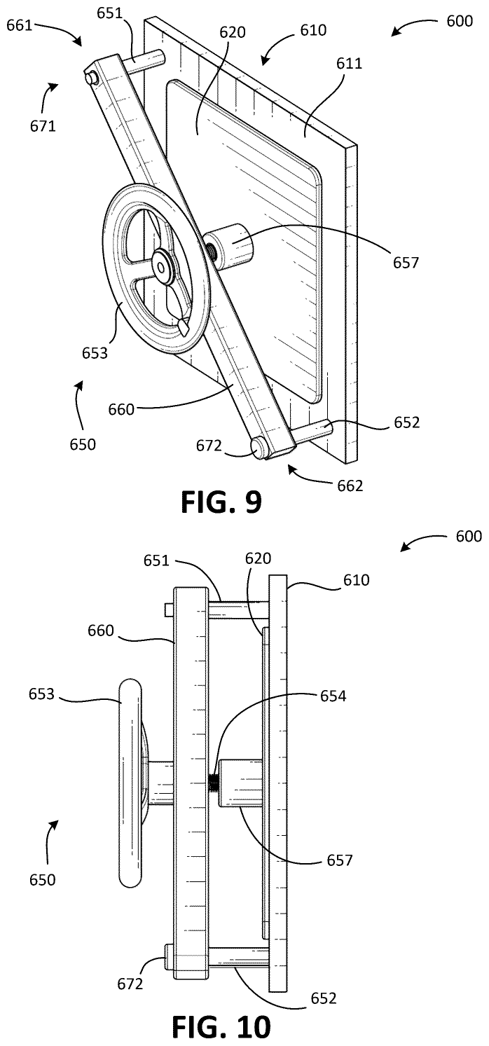

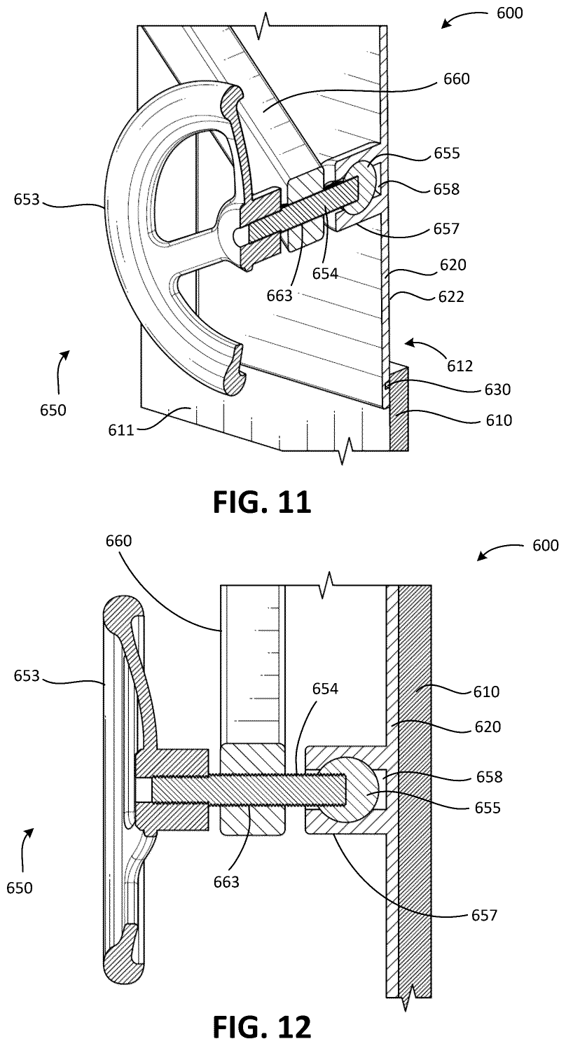

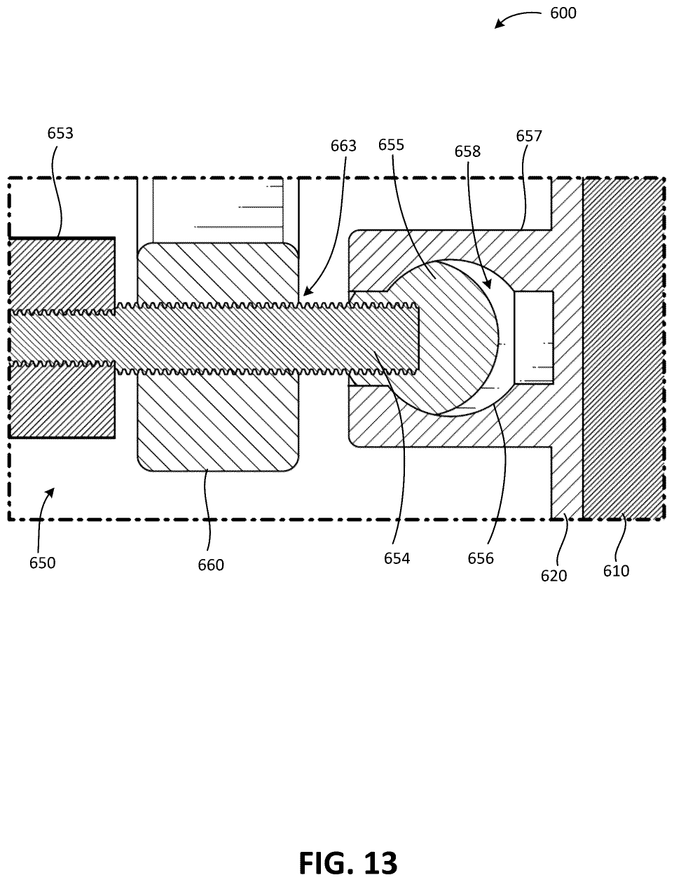

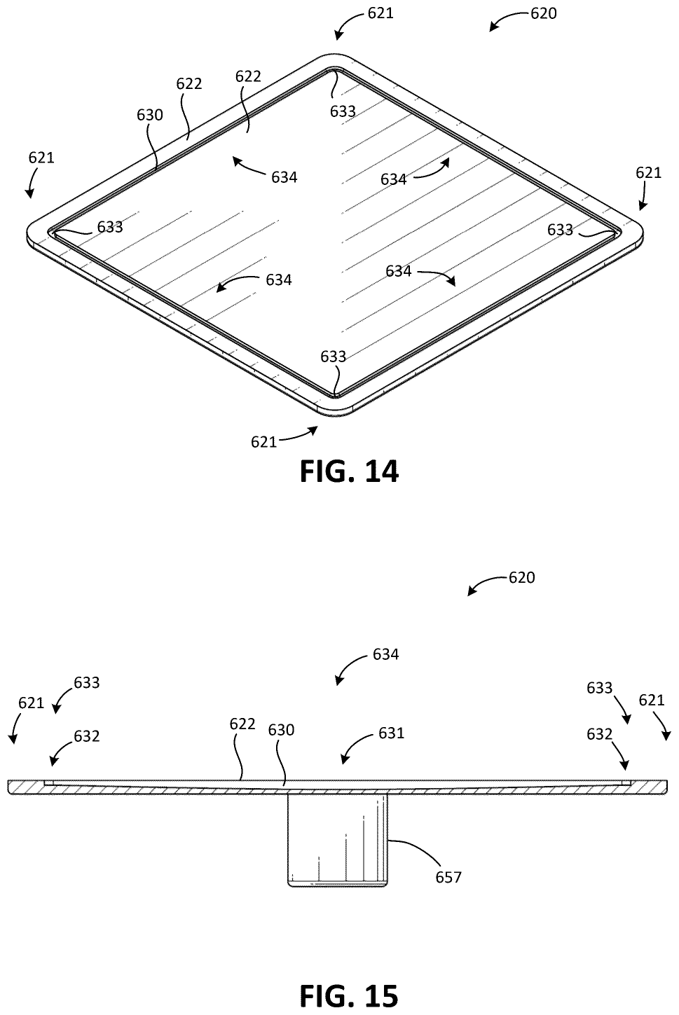

FIGS. 7-15 illustrate an example chamber door design comprising a seal structure configured to compensate for nonuniform deflection, while also reducing the overall weight, complexity, manufacturing costs, and maintenance issues of the door by obviating the need for additional door reinforcements that can be heavy, complex, costly, and/or maintenance-unfriendly. Specifically, FIG. 7 shows a perspective view of the chamber door placed under pressure, as previously described; FIG. 8 shows an exploded view of the chamber door and its associated compression mechanism components; FIG. 9 shows a perspective view of the chamber door and compression mechanism components (after assembly); FIG. 10 shows a side view of the assembled chamber door; FIG. 11 shows a cross-sectional perspective view of the assembled chamber door; FIG. 12 shows a cross-sectional side view of the assembled chamber door; FIG. 13 shows a close-up cross-sectional side view of a portion of the assembled chamber door; FIG. 14 shows a perspective view of the chamber door; and FIG. 15 shows a cross-sectional side view of the chamber door illustrating a variable depth channel, trench, trough, furrow, or groove formed therein.

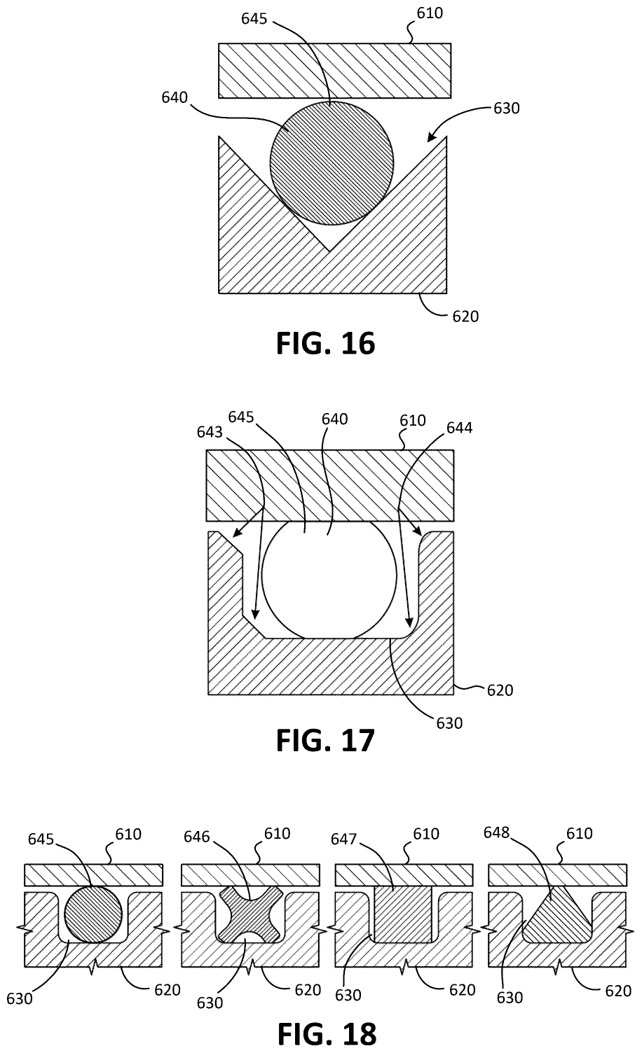

In some embodiments, a sealable chamber comprising the system shown in FIGS. 7-15 (and/or any variants thereof) may generally include: a chamber aperture 612 that is formed in a wall 606 or an aperture border 610 of the sealable chamber 600 that comprises a first surface 611 encompassing the chamber aperture 612, a chamber door 620 comprising a second surface 622 configured to engage against the first surface 611 of the aperture border 610, and a seal 640 (e.g., see FIGS. 16-20) positioned intermediate the first surface 611 and the second surface 622.

In some embodiments, the chamber door 620 (and/or the groove 630, and/or the chamber aperture 612) may comprise a non-circular shape which may result in nonuniform deflection when the chamber door 620 is placed under a compression force.

In some embodiments, at least a portion of the second surface 622 of the chamber door 620 may exhibit nonuniform deflection when a compression force 2 is applied to the chamber door 620 to compress at least a portion of the second surface 622 against the first surface 611.

In some embodiments, the non-circular shape of the chamber door 620 (and/or the groove 630, and/or the chamber aperture 612) may comprise a polygonal shape.

In some embodiments, the polygonal shape may comprise at least three sides and at least three corners.

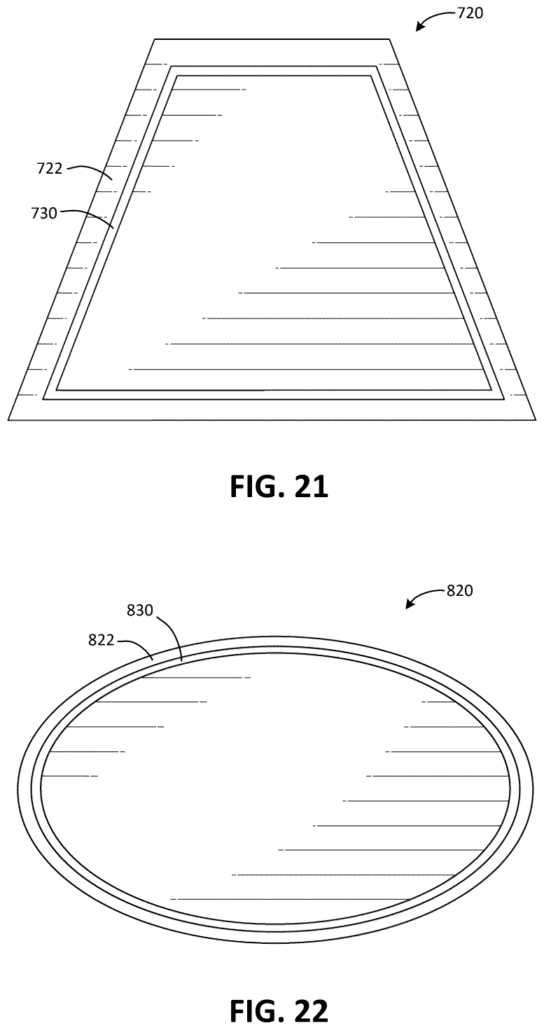

In some embodiments, the polygonal shape of the chamber door 620 (and/or the groove 630, and/or the chamber aperture 612) may comprise at least one of: triangular shape, a square shape (e.g., see FIG. 14), a rectangular shape, a trapezoidal shape (e.g., see the chamber door 720 in FIG. 21 with the second surface 722 and the groove 730 having trapezoidal shapes), and a rhomboid shape. However, it will be understood that the chamber door 620 may comprise any polygonal shape (e.g., a pentagonal shape, a hexagonal shape, an octagonal shape, etc.) or non-polygonal shape that is non-circular, without departing from the spirit or scope of the present disclosure.

In some embodiments, the non-circular shape of the chamber door 620 (and/or the groove 630, and/or the chamber aperture 612) may comprise a curved shape, an oval shape, an ovoid shape, an oblong shape, an elliptical shape, (e.g., see the chamber door 820 in FIG. 22 with the second surface 822 and the groove 830 having elliptical shapes), etc., and/or any other non-circular shape that comprises at least one curved side/edge having a shape that may result in nonuniform deflection when the chamber door 620 is placed under a compression force.

In some embodiments, the groove 630 may comprise the same shape (or substantially the same shape) as the chamber door 620.

In some embodiments, the chamber aperture 612 may comprise the same shape (or substantially the same shape) as the chamber door 620.

In some embodiments, a size of the chamber aperture 612 may by less than (or approximately equal to) a size of the chamber door 620.

In some embodiments, the seal 640 may comprise at least one of: an O-ring 645, an X-ring 646, a Square-ring 647, and a Delta-ring 648 (see FIGS. 16-20). However, it will be understood that the seal 640 may comprise any shape, configuration, or substance without departing from the spirit or scope of the present disclosure (e.g., any gasket or face seal configuration, any type of liquid seal, semi-liquid seal, or solid seal, etc.).

In some embodiments, the seal 640 may be placed directly on top of the first surface 611 and/or the second surface 622 (i.e., with no groove formed in either of the first surface 611 or the second surface 622 for receiving the seal 640 therein).

In some embodiments, a total height (or an exposed height) of the seal 640 may be configured to vary between the first surface 611 and/or the second surface 622 to compensate for any nonuniform deflection and maintain the hermetic seal between the first surface 611 and the second surface 622.

In some embodiments, the total height (or exposed height) of the seal 640 may continuously vary or increase/decrease (and/or may discretely vary or increase/decrease) moving from an intermediate portion 634 of a side of the chamber door 620 (or a side of the aperture border 610) toward a corner of the chamber door 620 (or toward a corner of the aperture border 610). Thus, the total height (or exposed height) of the seal 640 may be taller toward the corners to compensate for any nonuniform deflection the chamber door 620 may experience to maintain the hermetic seal. However, it will be understood that the total height (or exposed height) of the seal 640 may be varied in any manner to compensate for any specific nonuniform deflection characteristics that may be experienced by any given chamber door design based on its shape, size, material composition, thickness, the specific compression forces it will be subject to, etc.

In some embodiments, a variable-depth groove or groove 630 may be formed in at least one of the first surface 611 and/or the second surface 622 and configured to receive the seal 640 at least partially therein.

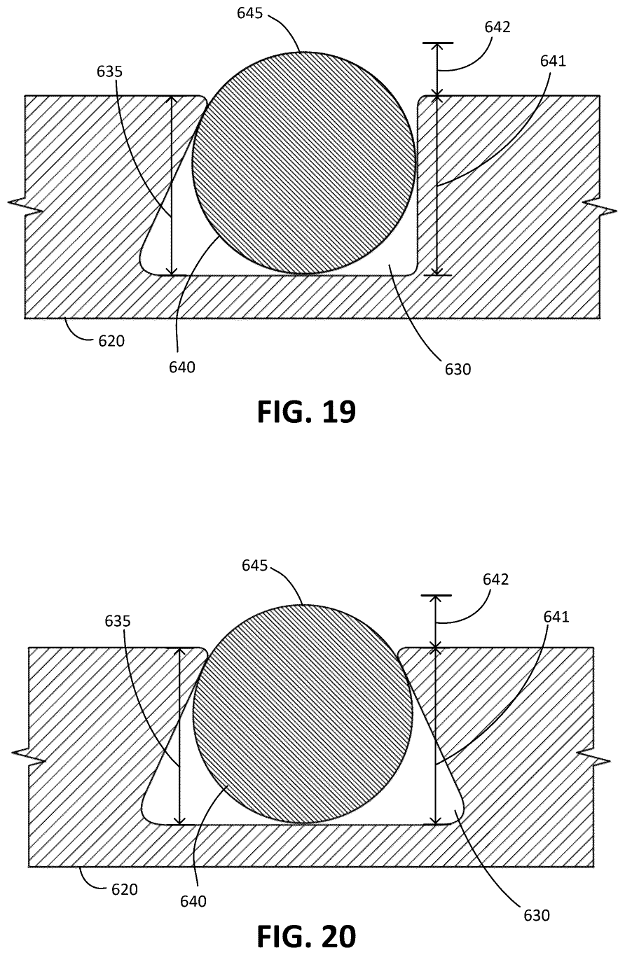

In some embodiments, a depth of the groove 630 (or groove depth 635; e.g., see FIGS. 19 and 20) may be configured to vary an exposed height 642 (and/or a concealed height 641) of the seal 640 to compensate for any nonuniform deflection and maintain the hermetic seal between the first surface 611 and the second surface 622.

In some embodiments, the groove depth 635 may continuously vary or increase/decrease (and/or may discretely vary or increase/decrease) moving from an intermediate portion 634 of a side of the chamber door 620 (or a side of the aperture border 610) toward a corner of the chamber door 620 (or toward a corner of the aperture border 610). For example, as shown in FIG. 15 the groove 630 may have an intermediate depth, maximum depth, or first depth 631 at a first location within the groove 630 toward the intermediate portion 634 of a side of the chamber door 620 (or at any low deflection area of the chamber door 620, depending on the specific shape of the door, the force applied, etc.), and the groove 630 may have a corner depth, minimum depth, or second depth 632 at a second location within the groove 630 toward a corner 633 (or at any high deflection area of the chamber door 620, depending on the specific shape of the door, the force applied, etc.) of the groove 630 that may be less than the first depth 631. In this manner, the variable depth groove may cause the exposed height 642 of the seal 640 to also vary/increase towards the corners of the groove 630 to compensate for any nonuniform deflection the chamber door 620 may experience and maintain the hermetic seal. However, it will be understood that the groove depth 635 may be varied in any manner to compensate for any specific nonuniform deflection characteristics that may be experienced by any given chamber door design based on its shape, size, material composition, thickness, the specific compression forces it will be subject to, etc.

In some embodiments, the first surface 611 of the aperture border 610 may comprise the groove 630 configured to at least partially receive the seal 640 therein, and the depth of the groove 630 in the first surface 611 may be configured to vary the exposed height 642 of the seal 640 to compensate for the nonuniform deflection and maintain the hermetic seal between the first surface 611 and the second surface 622.

In some embodiments, the second surface 622 of the chamber door 620 may comprise the groove 630 configured to at least partially receive the seal 640 therein, and the depth of the groove 630 in the second surface 622 may be configured to vary the exposed height 642 of the seal 640 to compensate for the nonuniform deflection and maintain the hermetic seal between the first surface 611 and the second surface 622.

In some embodiments, a cross-sectional shape of the groove 630 may comprise at least one of: a triangular groove (e.g., see FIG. 16), a square groove (e.g., see FIGS. 17 and 18), a rounded or ball-end groove (not shown), a partial or half dovetail groove (e.g., see FIG. 19), and full dovetail groove (e.g., see FIG. 20). However, it will be understood that any style, shape, or configuration for the groove 630 may be utilized without departing from the spirit or scope of the present disclosure. For example, in some embodiments the groove 630 may also include one or more chamfered surfaces 643 and/or one or more fillet surfaces 644, etc., placed anywhere within the groove (e.g., see FIG. 17).

Referring to FIGS. 8-13, in some embodiments the compression mechanism 650 may comprise a centrally located compression mechanism (or approximately centrally located compression mechanism) that may be configured to apply a centrally located compression force to the chamber door 620 to compress the second surface 622 of the chamber door 620 against the first surface 611 of the aperture border 610 of the sealable chamber.

In some embodiments, the compression mechanism 650 may generally include the handle 653, a threaded shaft 654 couplable with the handle 653 (at a proximal end of the threaded shaft 654), a compression member 655 (engaged with a distal end of the threaded shaft 654), the compression arm 660 couplable with the first compression arm support 651 and/or the second compression arm support 652, and a compression member housing 657 coupled to the chamber door 620.

In some embodiments, a first compression arm retainer 671 and/or a second compression arm retainer 672 may respectively hold the compression arm 660 in place on the first compression arm support 651 and/or on the second compression arm support 652 during a compression procedure, as will be explained below in more detail.

In some embodiments, the compression arm 660 may also include a pivot hole 664 formed in the first end 661 of the compression arm 660, a latch opening 665 formed in the second end 662 of the compression arm 660, and a threaded passageway 663 formed in a central portion of the compression arm 660. The threaded shaft 654 may be receivable within the threaded passageway 663 of the compression arm 660, and the compression member 655 may be receivable within a cavity 658 formed in the compression member housing 657 (e.g., see FIG. 13).

In some embodiments, as the handle 653 is rotated in a first direction, the threaded shaft 654 may protrude further from a distal side of the threaded passageway 663 causing the compression member 655 to move distally to contact against a compression surface 656 within a distal end of the cavity 658 formed in the compression member housing 657. In this manner, a compression force may be imparted on the chamber door 620 by rotating the handle 653 in the first direction and pressing the compression member 655 against the compression surface 656 within the compression member housing 657 to maintain the hermetic seal within the sealable chamber.

In some embodiments, as the handle 653 is rotated in a second direction, the threaded shaft 654 may retract into the threaded passageway 663 causing the compression member 655 to move proximally and disengage from the compression surface 656 within the cavity 658. In this manner, the compression force may be removed from the chamber door 620 by rotating the handle 653 in the second direction and releasing the compression member 655 from the compression surface 656 to allow the chamber door 620 to be opened and breach the hermetic seal within the sealable chamber.

Any procedures or methods disclosed herein may comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the present disclosure. This method of disclosure, however, is not to be interpreted as reflecting an intention that any embodiment requires more features than those expressly recited in that embodiment. Rather, inventive aspects lie in a combination of fewer than all features of any single foregoing disclosed embodiment.

Recitation of the term “first” with respect to a feature or element does not necessarily imply the existence of a second or additional such feature or element. Elements recited in means-plus-function format are intended to be construed in accordance with 35 U.S.C. § 112. It will be apparent to those having skill in the art that changes may be made to the details of the above-described embodiments without departing from the underlying principles set forth herein.

The phrases “connected to”, “coupled to”, “engaged with”, and “in communication with” may refer to any form of interaction between two or more entities, including mechanical, electrical, magnetic, electromagnetic, fluid, and thermal interaction. Two components may be functionally coupled to each other even though they are not in direct contact with each other. The term “coupled” can include components that are coupled to each other via integral formation (e.g., integrally formed as a single piece, etc.), components that are removably and/or non-removably coupled with each other, components that are functionally coupled to each other through one or more intermediary components, etc. The term “abutting” refers to items that may be in direct physical contact with each other, although the items may not necessarily be attached together. The phrase “fluid communication” refers to two or more features that are connected such that a fluid within one feature is able to pass into another feature.

As defined herein the term “substantially” means within +/−20% of a target value, measurement, or desired characteristic.

Standard planes of reference and descriptive terminology are employed in this specification. While these terms are commonly used to refer to the human body, certain terms may also be applicable to physical objects in general.

A standard system of three mutually perpendicular reference planes is employed. A sagittal plane divides a body into right and left portions. A coronal plane divides a body into anterior and posterior portions. A transverse plane divides a body into superior and inferior portions. A mid-sagittal, mid-coronal, or mid-transverse plane divides a body into equal portions, which may be bilaterally symmetric. The intersection of the sagittal and coronal planes defines a superior-inferior or cephalad-caudal axis. The intersection of the sagittal and transverse planes defines an anterior-posterior axis. The intersection of the coronal and transverse planes defines a medial-lateral axis. The superior-inferior or cephalad-caudal axis, the anterior-posterior axis, and the medial-lateral axis are mutually perpendicular.

Anterior means toward the front of a body. Posterior means toward the back of a body. Superior or cephalad means toward the head. Inferior or caudal means toward the feet or tail. Medial means toward the midline of a body, particularly toward a plane of bilateral symmetry of the body. Lateral means away from the midline of a body or away from a plane of bilateral symmetry of the body. Axial means toward a central axis of a body. Abaxial means away from a central axis of a body. Ipsilateral means on the same side of the body. Contralateral means on the opposite side of the body. Proximal means toward the trunk of the body. Proximal may also mean toward a user or operator. Distal means away from the trunk. Distal may also mean away from a user or operator.

While specific embodiments and applications of the present disclosure have been illustrated and described, it is to be understood that the scope of the present disclosure is not limited to the precise configurations and components disclosed herein. Various modifications, changes, and variations which will be apparent to those skilled in the art may be made in the arrangement, operation, and details of the devices, systems, and methods disclosed herein.

What is claimed is:

1. A sealable chamber comprising:
a chamber aperture;
an aperture border comprising a first surface encompassing the chamber aperture;
a chamber door comprising a second surface configured to at least partially engage against the first surface of the aperture border; and
a seal positioned intermediate the first surface and the second surface,
wherein:
the chamber door comprises a non-circular shape;
at least a portion of the second surface of the chamber door exhibits nonuniform deflection relative to the first surface of the aperture border when a compression force is applied to the chamber door to compress the second surface against the first surface; and
an exposed height of the seal intermediate the first surface and the second surface is configured to vary to compensate for the nonuniform deflection and maintain a hermetic seal between the first surface and the second surface.

2. The sealable chamber of claim 1, wherein:
at least one of:
the first surface of the aperture border; and
the second surface of the chamber door, comprises a groove configured to at least partially receive the seal therein; and
a depth of the groove is configured to vary the exposed height of the seal to compensate for the nonuniform deflection and maintain the hermetic seal between the first surface and the second surface.

3. The sealable chamber of claim 2, wherein:
the first surface of the aperture border comprises the groove configured to at least partially receive the seal therein; and
the depth of the groove in the first surface is configured to vary the exposed height of the seal to compensate for the nonuniform deflection and maintain the hermetic seal between the first surface and the second surface.

4. The sealable chamber of claim 2, wherein:
the second surface of the chamber door comprises the groove configured to at least partially receive the seal therein; and
the depth of the groove in the second surface is configured to vary the exposed height of the seal to compensate for the nonuniform deflection and maintain the hermetic seal between the first surface and the second surface.

5. The sealable chamber of claim 2, wherein the groove comprises:
a first depth at a first location within the groove; and
a second depth at a second location within the groove, wherein the depth of the groove is configured to continuously decrease moving from the first depth at the first location toward the second depth at the second location to vary the exposed height of the seal and compensate for the nonuniform deflection to maintain the hermetic seal between the first surface and the second surface.

6. The sealable chamber of claim 2, wherein the groove comprises:
a first depth at a first location within the groove; and
a second depth at a second location within the groove, wherein the depth of the groove is configured to discretely decrease moving from the first depth at the first location toward the second depth at the second location to vary the exposed height of the seal and compensate for the nonuniform deflection to maintain the hermetic seal between the first surface and the second surface.

7. The sealable chamber of claim 1, wherein the non-circular shape of the chamber door comprises at least one of:
a polygonal shape comprising at least one straight side; and
a curved shape comprising at least one curved side.

8. A sealable chamber comprising:
a chamber aperture;
an aperture border comprising a first surface encompassing the chamber aperture;
a chamber door comprising:
a polygonal shape; and
a second surface configured to at least partially engage against the first surface of the aperture border; and
a seal positioned intermediate the first surface of the aperture border and the second surface of the chamber door,
wherein:
at least a portion of the second surface of the chamber door exhibits nonuniform deflection relative to the first surface of the aperture border when a compression force is applied to the chamber door to compress the second surface against the first surface; and
an exposed height of the seal intermediate the first surface and the second surface is configured to vary to compensate for the nonuniform deflection and maintain a hermetic seal between the first surface and the second surface.

9. The sealable chamber of claim 8, wherein:
at least one of:
the first surface of the aperture border; and
the second surface of the chamber door, comprises a groove configured to at least partially receive the seal therein; and
a depth of the groove is configured to vary the exposed height of the seal to compensate for the nonuniform deflection and maintain the hermetic seal between the first surface and the second surface.

10. The sealable chamber of claim 9, wherein:
the second surface of the chamber door comprises the groove configured to at least partially receive the seal therein; and
the depth of the groove in the second surface is configured to vary the exposed height of the seal to compensate for the nonuniform deflection and maintain the hermetic seal between the first surface and the second surface.

11. The sealable chamber of claim 9, wherein the groove comprises:
an intermediate depth at an intermediate portion along at least one side of the chamber door; and
a corner depth at a corner of the chamber door, wherein the depth of the groove is configured to decrease moving from the intermediate depth toward the corner depth to vary the exposed height of the seal and compensate for the nonuniform deflection to maintain the hermetic seal between the first surface and the second surface.

12. The sealable chamber of claim 8, wherein the polygonal shape of the chamber door comprises at least three sides and at least three corners.

13. The sealable chamber of claim 12, wherein the polygonal shape comprises at least one of:
a triangular shape;
a square shape;
a rectangular shape;
a trapezoidal shape; and
a rhomboid shape.

14. The sealable chamber of claim 8, further comprising a compression mechanism configured to apply the compression force to the chamber door to compress the second surface against the first surface.

15. A sealable chamber comprising:
a sealable chamber wall comprising:
a chamber aperture formed therethrough; and
an aperture border comprising a first surface encompassing the chamber aperture;
a chamber door comprising:
a curved shape; and
a second surface configured to at least partially engage against the first surface of the sealable chamber wall; and
a seal positioned intermediate the first surface of the sealable chamber wall and the second surface of the chamber door,
wherein:
at least a portion of the second surface of the chamber door exhibits nonuniform deflection relative to the first surface of the sealable chamber wall when a compression force is applied to the chamber door to compress the second surface against the first surface; and
an exposed height of the seal intermediate the first surface and the second surface is configured to vary to compensate for the nonuniform deflection and maintain a hermetic seal between the first surface and the second surface.

16. The sealable chamber of claim 15, wherein:
at least one of:
the first surface of the sealable chamber wall; and
the second surface of the chamber door, comprises a groove configured to at least partially receive the seal therein; and
a depth of the groove is configured to vary the exposed height of the seal to compensate for the nonuniform deflection and maintain the hermetic seal between the first surface and the second surface.

17. The sealable chamber of claim 16, wherein:
the second surface of the chamber door comprises the groove configured to at least partially receive the seal therein; and
the depth of the groove in the second surface is configured to vary the exposed height of the seal to compensate for the nonuniform deflection and maintain the hermetic seal between the first surface and the second surface.

18. The sealable chamber of claim 16, wherein the groove comprises at least one of:
a triangular groove;
a square groove;
a rounded groove;
a half dovetail groove; and
a full dovetail groove.

19. The sealable chamber of claim 15, wherein the curved shape comprises at least one of:
an oval shape;
an ovoid shape;
an oblong circular shape; and
an elliptical shape.

20. The sealable chamber of claim 15, wherein the seal comprises at least one of:
an O-ring;
an X-ring;
a square-ring; and
a delta-ring.
